(19) United States
(12) Patent Application Publication
(10) Pub. No.: US 2016/0295143 A1
(43) Pub. Date: Oct. 6, 2016

(54) PIXEL AMPLIFICATION APPARATUS AND CMOS IMAGE SENSOR INCLUDING THE SAME

(71) Applicant: SK hynix Inc., Gyeonggi-do (KR)

(72) Inventors: Hyun-Mook PARK, Gyeonggi-do (KR); Gun-Hee YUN, Gyeonggi-do (KR)

(21) Appl. No.: 14/831,489

(22) Filed: Aug. 20, 2015

(30) Foreign Application Priority Data
Mar. 31, 2015 (KR) 10-2015-0045053

(51) Int. Cl. H04N 5/378; H04N 5/369

(52) U.S. Cl. CPC H04N 5/378; H04N 5/369

(57) ABSTRACT

A pixel amplification apparatus includes a single common current source suitable for supplying an identical current to columns, a plurality of column selection units each suitable for selecting each column to allow a corresponding current to flow, a plurality of pixel bias sampling units each suitable for sampling the corresponding current flowing through each of the column selection units as a pixel bias, and a plurality of amplification units each suitable for amplifying to a pixel signal based on the sampled pixel bias.

### CROSS-REFERENCE TO RELATED APPLICATIONS

The present application claims priority of Korean Patent Application No. 10-2015-0045053, filed on Mar. 31, 2015, which is incorporated herein by reference in its entirety.

### BACKGROUND

1. Field

Various embodiments of the present invention relate to an image sensor, and more particularly, to a pixel amplification apparatus for sampling a pixel bias and a CMOS image sensor including the same.

2. Description of the Related Art

In CMOS image sensors, noise due to power noise and coupling may be added to a pixel bias.

The noise added to the pixel bias can hurt image quality when processing each row of the image.

In general, a current bias sampling scheme has been used to resolve such concerns.

When a conventional current bias sampling scheme is used, all columns are biased through respective bias transistors having the same size and based on one reference, using a current mirroring structure.

In the conventional current bias sampling scheme, however, when bias sampling is performed using a current mirroring structure, the amount of current that flows in each column varies due to a mismatch between the size and/or threshold voltage of the bias transistors of each of the columns.

Therefore, a mismatch between columns may occur, resulting in fixed pattern noise (FPN) in the generated images.

### SUMMARY

Various embodiments are directed to a pixel amplification apparatus capable of sequentially sampling the pixel biases of respective columns using a single common current source, and a CMOS image sensor including the same.

In an embodiment, a pixel amplification apparatus may include a single common current source suitable for supplying an identical current to a plurality of columns; a plurality of column selection units each suitable for selecting each column to allow a corresponding current to flow; a plurality of pixel bias sampling units each suitable for sampling the corresponding current flowing through each of the column selection units as a pixel bias; and a plurality of amplification units each suitable for amplifying a pixel signal based on the sampled pixel bias.

The columns may be sequentially selected by the column selection units.

A column selection unit and A corresponding pixel bias sampling unit are simultaneously turned on/off.

In an embodiment, a CMOS image sensor may include a pixel array including a plurality of pixels coupled to a plurality of rows and columns; a row decoder/pixel driver suitable for selecting a pixel of the pixel array and driving the selected pixel; a pixel amplification unit suitable for sequentially sampling pixel biases of the columns using a single common current source to amplify a pixel signal generated from the pixel array; and a read-out processing unit suitable for outputting the amplified pixel signal.

The pixel amplification unit may include a single common current source suitable for supplying an identical current to the columns; a plurality of column selection units each suitable for selecting each column to allow a corresponding current to flow; a plurality of pixel bias sampling units each suitable for sampling the corresponding current flowing through each of the column selection units as a pixel bias; and a plurality of amplification units each suitable for amplifying the pixel signal based on the sampled pixel bias.

The columns are sequentially selected by the respective column selection units.

A column selection unit and A corresponding pixel bias sampling unit are simultaneously turned on/off.

In an embodiment, a pixel amplification apparatus may include a first common current source suitable for supplying an identical current to a first column group; a second common current source suitable for supplying an identical current to a second column group; a plurality of column selection units each suitable for selecting each column to allow a corresponding current to flow; a plurality of pixel bias sampling units each suitable for sampling the corresponding current flowing through each of the column selection units as a pixel bias; and a plurality of amplification units each suitable for amplifying a pixel signal based on the sampled pixel bias.

### BRIEF DESCRIPTION OF THE DRAWINGS

FIG. 1 is a diagram illustrating a CMOS image sensor using a local bias sampling scheme.

FIG. 2 is a diagram illustrating a CMOS image sensor using a global bias sampling scheme.

FIG. 3 is a diagram illustrating a pixel amplification apparatus using a single common current source in accordance with an embodiment of the present invention.

FIG. 4 is a diagram illustrating a CMOS image sensor in accordance with an embodiment of the present invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts in the various figures and embodiments of the present invention.

In this disclosure, when one part is referred to as being ‘connected’ to another part, it should be understood that the former can be ‘directly connected’ to the latter, or ‘electrically connected’ to the latter via an intervening part. Furthermore, when it is described that one comprises (or includes or has) some elements, it should be understood that it may comprise (or include or has) only those elements or it may comprise or include or have) other elements as well as those elements if there is no specific limitation. The terms of singular form may include plural forms unless stated otherwise.

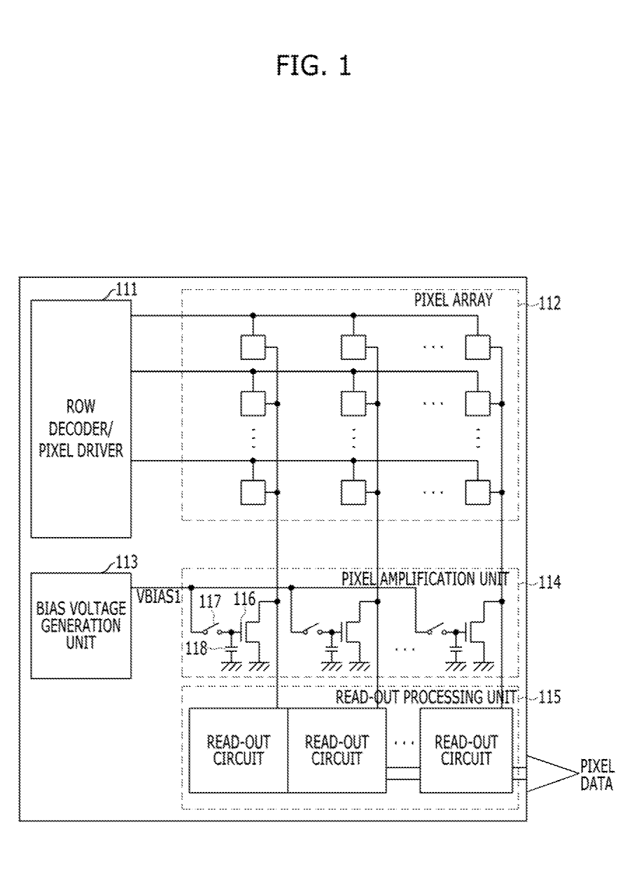

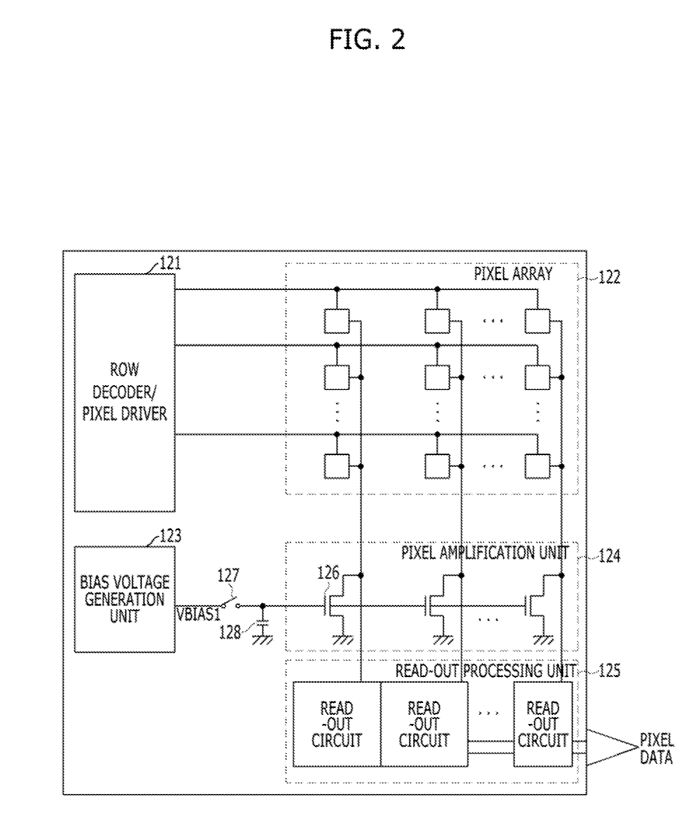

FIG. 1 is a diagram illustrating a CMOS image sensor using a local bias sampling scheme, and FIG. 2 is a diagram illustrating a CMOS image sensor using a global bias sampling scheme.

Referring to FIGS. 1 and 2, the CMOS image sensor may include a row decoder/pixel driver 111 or 121, a pixel array 112 or 122, a bias voltage generation unit 113 or 123, a pixel amplification unit 114 or 124, and a read-out processing unit 115 or 125.

The row decoder/pixel driver 111 or 121 may include a row decoder and a pixel driver, The pixel driver drives pixels that are included in the pixel array 112 or 122 and selected by the row decoder.

The pixel array 112 or 122 senses light using an optical device and generates a pixel signal corresponding to the sensed light. In this case, a pixel that is included in the pixel array 112 or 122 and selected by the row decoder and driven by the pixel driver outputs a pixel signal. The pixel signal is an analog pixel signal (i.e., an electrical signal).

The bias voltage generation unit 113 or 123 generates a bias voltage VBIAS1 and applies the bias voltage VBIAS1 to a bias transistor (referred to as a load transistor) 116 or 126 of the pixel amplification unit 114 or 124.

The pixel amplification unit 114 or 124 amplifies the pixel signal from the pixel array 112 or 122 and transfers the amplified pixel signal to the read-out processing unit 115 or 125. The pixel amplification unit 114 or 124 includes a plurality of bias transistors corresponding to the respective columns.

The read-out processing unit 115 or 125 outputs the amplified pixel signal as pixel data. The read-out processing unit 115 or 125 includes a plurality of read-out circuits corresponding to the respective columns.

The bias voltage VBIAS1 applied to the bias transistor 116 or 126 of the pixel amplification unit 114 or 124 is directly supplied by the bias voltage generation unit 113 or 123. Accordingly, image quality may be deteriorated because of circuit noise generated from the bias voltage generation unit 113 or 123 is applied to the bias transistor 116 or 126 along with the bias voltage VBIAS1.

To prevent the deterioration of image quality due to such noise, a local bias sampling scheme or a global bias sampling scheme is used. In the local bias sampling scheme, a sampling switch 117 and a sampling capacitor 118 correspond to each column of the pixel amplification unit 114 (see FIG. 1). In the global bias sampling scheme, a sampling switch 127 and a sampling capacitor 128 are used in all the columns of the pixel amplification unit 124 (see FIG. 2).

As illustrated in FIG. 1, however, the local bias sampling scheme requires a relatively large circuit area because a plurality of the large-capacity sampling capacitors 118 for preventing deterioration of linearity due to the coupling of output nodes of the pixel array 112.

As illustrated in FIG. 2, when the global bias sampling scheme is used, a relatively small circuit area is needed. However, the amount of current flowing in each column may be varied due to a mismatch between the sizes and/or threshold voltages of the bias transistors corresponding to the respective columns when bias sampling is performed using a current mirror structure.

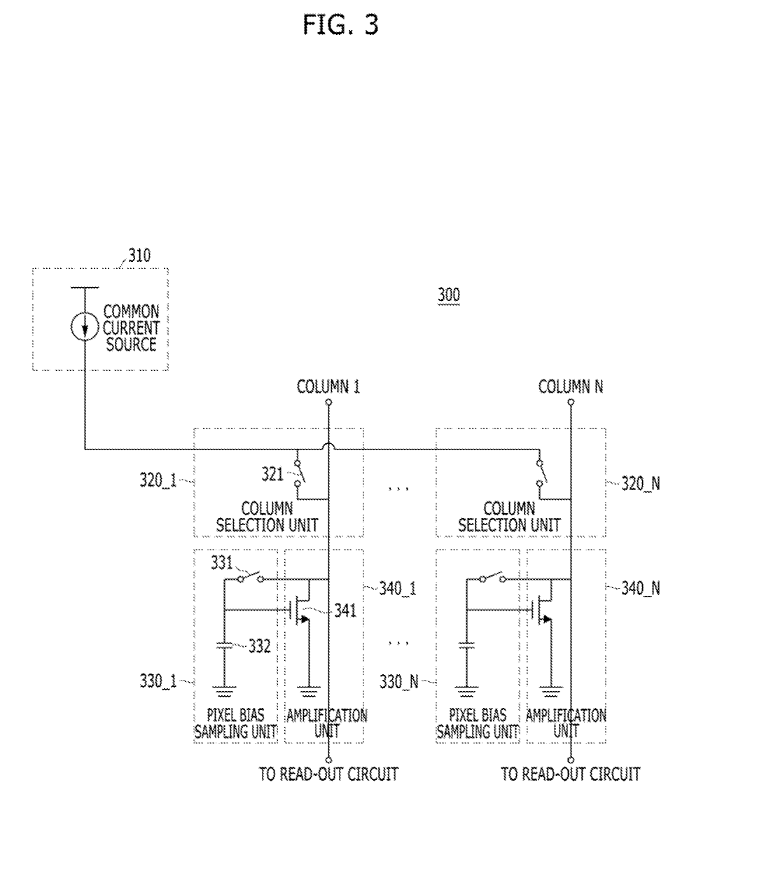

FIG. 3 is a diagram illustrating a pixel amplification apparatus 300 using a single common current source in accordance with an embodiment of the present invention.

As illustrated in FIG. 3, the pixel amplification apparatus 300 may include a single common current source 310, a plurality of column selection units 320_1 to 320_N, a plurality of pixel bias sampling units 330_1 to 330_N, and a plurality of amplification units 340_1 to 340_N. The common current source 310 may supply the same amount of current to respective columns (COLUMN_1 to COLUMN_N) in common. Each of the column selection units 320_1 to 320_N may select a corresponding column in response to an external control signal so that an electric current from the common current source 310 flows, Each of the pixel bias sampling units 330_1 to 330_N may sample an electric current flowing through each of the column selection units 320_1 to 320_N as pixel bias. Each of the amplification units 340_1 to 340_N may operate in response to a corresponding pixel bias sampled by the respective pixel bias sampling units 330_1 to 330_N to amplify a pixel signal.

As illustrated in FIG. 3, the common current source 310 may be implemented to supply the same amount of current to all the columns. If the number of columns is great, the columns may be in groups of two or three, and one common current source may be included in each column group. In other words, a single common current source may supply the same amount of current to a corresponding column group.

For example, the column selection unit 320_1 may include a column selection switch 321. The column selection switch 321 is controlled by a control signal (not illustrated) applied from an external control unit (e.g., a timing generator). In this case, the control signal may enable the columns to be sequentially selected by the column selection switches.

For example, the pixel bias sampling unit 330_1 samples an electric current flowing through the column selection unit 320_1 and uses the sampled current as a corresponding pixel bias. The pixel bias sampling unit 330_1 may include a sampling switch 331 and a sampling capacitor 332. The sampling switch 331 may be turned on/off simultaneously with the column selection switch 321 in response to the control signal. As a result, the column selection unit 320_1 and the pixel bias sampling unit 330_1 may be simultaneously enabled.

For example, the amplification unit 340_1 may include a bias transistor 341. The bias transistor 341 may operate in response to a corresponding pixel bias, sampled by the pixel bias sampling unit 330_1 and received through its gate terminal, to amplify a corresponding pixel signal. The bias transistor 341 may be an NMOS transistor having a drain coupled to the column COLUMN_1 the gate receiving the sampled pixel bias, and a source coupled to a ground power source.

As described above, according to the embodiment of the present invention, a current mismatch between columns may be minimized by sequentially sampling the pixel biases of the respective columns using the common current source 310. That is, the pixel biases of respective columns are sequentially sampled using the common current source 310 to minimize current errors due to a mismatch between the size and/or threshold voltage of the bias transistors and thereby prevent the generation of an FPN,

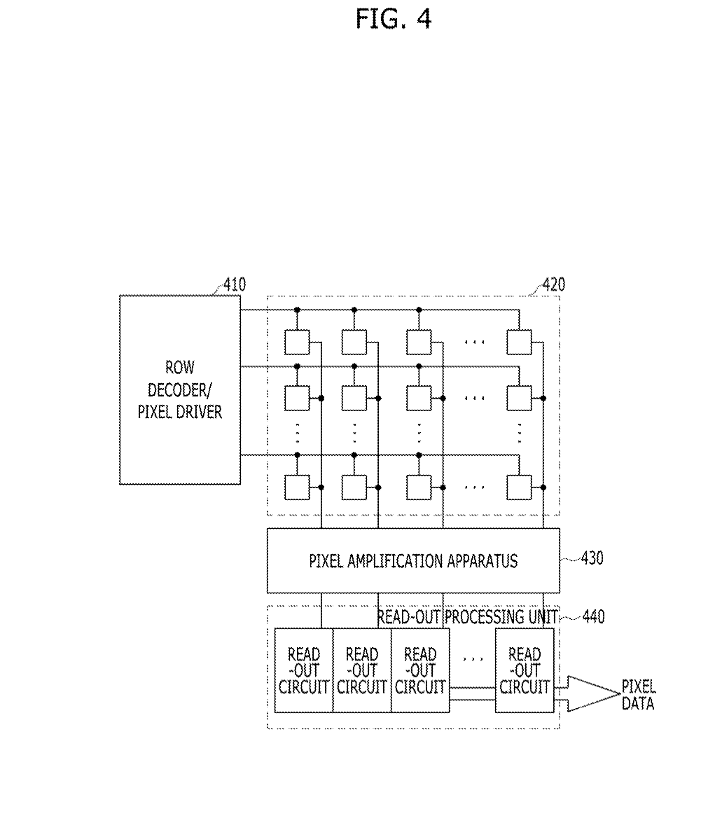

FIG. 4 is a diagram illustrating a CMOS image sensor in accordance with an embodiment of the present invention.

As illustrated in FIG. 4, the CMOS image sensor may include a row decoder/pixel driver 410, a pixel array 420, a pixel amplification unit 430, and a read-out processing unit 440.

The row decoder/pixel driver 410 may include a row decoder and a pixel driver. The pixel driver drives pixels that are included in the pixel array 420 and selected by the row decoder.

The pixel array 420 senses light using an optical device and generates a pixel signal corresponding to the sensed light. In this case, a pixel that is included in the pixel array 420 and selected by the row decoder and driven by the pixel driver outputs a pixel signal. The pixel signal is an analog pixel signal (i.e., an electrical signal).

The pixel amplification unit 430 may have the same configuration as the pixel amplification apparatus 300 shown in FIG. 3. The pixel amplification unit 430 sequentially samples the pixel biases of respective columns using the common current source and amplifies a pixel signal from the pixel array 420.

The read-out processing unit 440 outputs the amplified pixel signal as pixel data. The read-out processing unit 440 includes a plurality of read-out circuits corresponding to the respective columns.

In accordance with the embodiment of the present invention, current mismatching between columns may be minimized by sequentially sampling the pixel biases of columns using a common current source.

Furthermore, in accordance with an embodiment of the present invention, there is an advantage in that the FPM of the generated image may be minimized by minimizing current mismatch between columns as described above.

Although various embodiments have been described for illustrative purposes, it will be apparent to those skilled in the art that various changes and modifications may be made without departing from the spirit and scope of the invention as defined in the following claims.

What is claimed is:

1. A pixel amplification apparatus, comprising. a single common current source suitable for supplying an identical current to a plurality of columns;
a plurality of column selection units each suitable for selecting each column to allow a corresponding current to flow;
a plurality of pixel bias sampling units each suitable for sampling the corresponding current flowing through each of the column selection units as a pixel bias; and
a plurality of amplification units each suitable for amplifying a pixel signal based on the sampled pixel bias.

2. The pixel amplification apparatus of claim 1, wherein the columns are sequentially selected by the column selection units.

3. The pixel amplification apparatus of claim 1, wherein a column selection unit and a corresponding pixel bias sampling unit are simultaneously turned on/off.

4. A CMOS image sensor, comprising:
a pixel array including a plurality of pixels coupled to a plurality of rows and columns;
a row decoder/pixel driver suitable for selecting a pixel of the pixel array and driving the selected pixel;
a pixel amplification unit suitable for sequentially sampling pixel biases of the columns using a single common current source to amplify a pixel signal generated from the pixel array; and
a read-out processing unit suitable for outputting the amplified pixel signal.

5. The CMOS image sensor of claim 4, wherein the pixel amplification unit comprises:
a single common current source suitable for supplying an identical current to the columns;
a plurality of column selection units each suitable for selecting each column to allow a corresponding current to flow;
a plurality of pixel bias sampling units each suitable for sampling the corresponding current flowing through each of the column selection units as a pixel bias; and
a plurality of amplification units each suitable for amplifying the pixel signal based on the sampled pixel bias.

6. The CMOS image sensor of claim 5, wherein the columns are sequentially selected by the respective column selection units.

7. The CMOS image sensor of claim wherein a column selection unit and a corresponding pixel bias sampling unit are simultaneously turned on/off.

8. A pixel amplification apparatus, comprising:
a first common current source suitable for supplying an identical current to a first column group;
a second common current source suitable or supplying an identical current to a second column group;
a plurality of column selection units each suitable for selecting each column to allow a corresponding current to flow;
plurality of pixel bias sampling units each suitable for sampling the corresponding current flowing through each of the column selection units as a pixel bias; and
a plurality of amplification units each suitable for amplifying a pixel signal based on the sampled pixel bias.
